(19) United States
(12) Patent Application Publication
(10) Pub. No.: US 2023/0302938 A1
(43) Pub. Date: Sep. 28, 2023

(54) Device and Method for Determining the Overall Amount of Energy for a Charging Process

(71) Applicant: Bayerische Motoren Werke Aktiengesellschaft, Muenchen (DE)

(72) Inventors: Florian BIRNTHALER, Muenchen (DE); Christopher DAVID, Muenchen (DE); Karlheinz SEIDLER, Petershausen (DE)

(21) Appl. No.: 18/023,213

(22) PCT Filed: Aug. 13, 2021
(86) PCT No.: PCT/EP2021/072617

§ 371 Date: Feb. 24, 2023

(30) Foreign Application Priority Data
Aug. 27, 2020 (DE) 10 2020 122 426.5

(51) Int. Cl. B60L 53/62; B60L 58/12; B60L 53/66

(52) U.S. Cl. CPC B60L 53/62; B60L 58/12; B60L 53/665; B60L 2260/46; B60L 2260/54

(57) ABSTRACT

A device for determining the overall amount of energy for a charging process of an electric energy store of an at least partially electrically driven vehicle at a charging station is provided. The device is configured to determine a vehicle-related amount of energy of electric energy, which has been drawn by the vehicle for the charging process. Furthermore, the device is configured to estimate the overall amount of energy, which was determined prior thereto by way of an estimation unit based on the vehicle-related amount of energy, which is drawn by the charging station from an electric supply source for carrying out the charging process.

### BACKGROUND AND SUMMARY OF THE INVENTION

The invention relates to a device and a corresponding method for determining the overall amount of energy for a charging process at a charging station.

Vehicles with an electric drive (particularly electric vehicles or plug-in hybrid vehicles) comprise electrical energy stores (e.g. batteries) which, by way of a charging device of the vehicle, can be connected to a charging station and charged. For the charging of the electrical energy store, various conductive i.e. cable-based charging technologies exist. In the case of “AC charging”, or alternating current charging, the charging device, by way of which converted direct current (also described as DC) is delivered for the charging of the electrical energy store, is located in the vehicle. An AC (alternating current) is transmitted on a charging cable between the charging station and the vehicle. In the case of “DC charging”, or direct current charging, a DC (direct current) is transmitted on the charging cable.

A vehicle, in advance of a charging process or during a charging process, can typically only determine the amount of energy which is drawn by the vehicle, particularly at the charging socket of the vehicle. The overall amount of energy which needs to be drawn by the charging station from an electric power supply grid for the execution of the charging process, and which is typically billed to the user of the vehicle, cannot generally be determined by the vehicle.

The technical object addressed by the present document is the enablement of a vehicle, in an accurate and efficient manner, to determine the overall amount of energy required for a charging process.

This object is fulfilled by the claimed invention. It should be observed that additional features of a patent claim which is dependent upon an independent patent claim, in the absence of the features of the independent patent claim, or in combination with only a proportion of the features of the independent patent claim, can define a standalone invention, which is independent of the combination of all the features of the independent patent claim, and which can be the subject matter of an independent claim, a divisional application or a subsequent application. The same applies, in a corresponding manner, to the technical instruction disclosed in the description, which can define an invention which is independent of the features of the independent patent claims.

According to one aspect, a device is described for determining the overall amount of energy for a charging process of an electrical energy store of at least partially electrically-powered vehicle at a charging station. The vehicle can be a battery electric vehicle (BEV), a plug-in hybrid vehicle, or a vehicle with a range extender. The charging station can be configured to execute a cable-based (AC or DC) charging process, or an inductive charging process.

The device can be designed to determine a vehicle-related amount of energy, in the form of electrical energy, which is drawn by the vehicle for the charging process. The vehicle-related amount of energy can be measured within the vehicle during the charging process. Alternatively or additionally, the vehicle-related amount of energy can be estimated in advance of the charging process. In particular, the device can be designed to determine the vehicle-related amount of energy for the charging process during the charging process, on the basis of sensor data from an energy metering unit of the vehicle. Alternatively or additionally, the device can be designed to determine the vehicle-related amount of energy for the charging process prior to the commencement of the charging process, on the basis of the state-of-charge, particularly on the basis of the actual state-of-charge of the electrical energy store of the vehicle and/or on the basis of one or more customer settings currently in force. One exemplary customer setting is the target state-of-charge of the electrical energy store further to the charging process. In particular, the vehicle-related amount of energy for the charging process can be determined on the basis of the difference between the (preset) target state-of-charge (at the end of the charging process) and the (existing) actual state-of-charge of the electrical energy store (at the start of the charging process). The vehicle-related amount of energy can optionally be determined exclusively on the basis of information which is available in the vehicle.

The device is further designed, by way of an estimation unit which is determined in advance, to estimate, on the basis of the vehicle-related amount of energy, the overall amount of energy which is drawn by the charging station from an electric power supply source (e.g. from an electric power supply grid) for the charging process.

The estimation unit can comprise an estimation algorithm, which is machine-trained beforehand on the basis of training data, for the estimation of the overall amount of energy for a charging process on the basis of the vehicle-related amount of energy drawn by the vehicle. Alternatively or additionally, the estimation unit can comprise a neural network, which is machine-trained beforehand on the basis of training data, for the estimation of the overall amount of energy for a charging process.

The estimation unit can particularly be designed to estimate the amount of electrical energy losses which are consumed or which occur during the charging process on the charging station and/or or a charging cable between the charging station and the vehicle (i.e. outside the vehicle). The overall amount of energy is then determined on the basis of, or as the sum of the vehicle-related amount of energy and the amount of electrical energy losses.

A device is thus described which (particularly in a vehicle), on the sole basis of information which is available in the vehicle, permits the estimation of the overall amount of energy for a charging process (which also includes at least a proportion of energy which is generated externally to the vehicle or consumed externally to the vehicle). Convenience for a user of the vehicle in conjunction with charging processes of the vehicle (particularly with respect to the selection of an appropriate charging station) and/or the energy efficiency of the vehicle (by the selection of a particularly energy-efficient charging station for a charging process) can be enhanced accordingly.

The estimation unit can be trained in advance (optionally by way of the device). To this end, a plurality of training data records for a corresponding plurality of (previously executed) charging processes (i.e. training data) can be considered. The training data record for a previously executed charging process can indicate the actual vehicle-related amount of energy and the actual overall amount of energy for the previously executed charging process. Optionally, the training data record can also comprise charging station data and/or charging process data for the (previously executed) charging process, in order to enhance the accuracy of the estimation of the overall amount of energy (as described hereinafter).

The estimation unit, particularly the estimation algorithm and/or the neural network, can then be trained on the basis of the plurality of training data records. A machine-trained estimation unit can thus be provided. The quality of estimation of the estimation unit can be further enhanced accordingly.

The device can be designed to determine charging station data with reference to the charging station at which the charging process for the charging of the electrical energy store of the vehicle is to be executed.

Charging station data can comprise an identifier for the identification of the charging station from a plurality of different charging stations. Alternatively or additionally, charging station data can comprise positional information with respect to a position of the charging station. Charging station data can thus be provided which permit an individual identification of the charging station at which the charging process is to be executed, or is being executed. The estimation unit can be trained in advance for specific individual charging stations (and thus in consideration of respective energy losses in the respective charging station). The overall amount of energy can then be determined by way of the estimation unit, in a particularly accurate manner, on the basis of charging station data.

Alternatively or additionally, charging station data can indicate the type of charging process from a plurality of different types of charging processes which are executable on the charging station or executed on the charging station. The plurality of different types of charging processes can comprise a DC charging process, an AC charging process and/or an inductive charging process. Charging station data can thus be provided which indicate the type of charging process which is executable or executed on the respective charging station. The estimation unit can be trained in advance for specific individual types of charging processes (in order to permit the consideration of energy losses associated with different types of charging processes). The overall amount of energy can then be determined by way of the estimation unit, in a particularly accurate manner, on the basis of charging station data.

The device can be designed to determine charging process data with reference to the charging process which is to be employed, or which is employed for the charging of the energy store of the vehicle. Charging process data can thus indicate e.g. the (maximum or average) charging capacity for the charging process. The estimation unit can be trained in advance for different charging process data, and particularly for different charging capacities (such that energy losses for different charging capacities can be considered). The overall amount of energy can then be determined by way of the estimation unit, in a particularly accurate manner, on the basis of charging station data.

The device can be designed, for a plurality of different charging stations (e.g. in the vicinity of the current position of the vehicle), to respectively determine, on the basis of the vehicle-related amount of energy (optionally by reference to the state-of-charge of the energy store), the overall amount of energy for a charging process at the respective charging station. It can therefore be determined what overall amount of energy is required for charging the electrical energy store at the different charging stations. A distinction can thus be drawn between overall amounts of energy for the different charging stations, on the basis of the different energy efficiency of the individual charging stations.

The device can further be designed to deliver an output of energy information with respect to the overall amounts of energy thus determined for the plurality of different charging stations to the user of the vehicle (e.g. via a user interface of the vehicle). Overall quantities of energy required for the charging of the energy store of the vehicle at the different charging stations can thus be indicated to the user. This permits the user to select a particularly energy-efficient charging station for the charging process. The energy efficiency of the vehicle can be enhanced accordingly.

According to a further aspect, a (road) motor vehicle (particularly a passenger motor vehicle, a heavy goods vehicle, a bus or a motorcycle) is described which comprises the device described in the present document.

According to a further aspect, a method is described for determining the overall amount of energy for a charging process of an electrical energy store of an at least partially electrically-powered vehicle at a charging station. The method comprises the determination of the vehicle-related amount of energy, in the form of electrical energy, which is drawn by the vehicle for the charging process (for the charging of the electrical energy store). The method further comprises the estimation, by way of an estimation unit which has been established beforehand, on the basis of the vehicle-related amount of electrical energy, of the overall amount of energy drawn by the charging station from an electric power supply source (e.g. from an electric power supply grid) for the execution of the charging process.

According to a further aspect, a method for the (machine) training of an estimation unit is described, wherein the estimation unit is enabled, on the basis of a vehicle-related amount of energy in the form of electrical energy which is drawn by a vehicle during a charging process at a charging station, to estimate an overall amount of energy which is drawn for the charging process by the charging station from an electric power supply source.

The method comprises the determination of a plurality of training data records for a corresponding plurality of charging processes, wherein the training data record for a charging process indicates the vehicle-related amount of energy and the overall amount of energy for the charging process. The method further comprises the training of the estimation unit on the basis of the plurality of training data records.

According to a further aspect, a software (SW) program is described. The SW program can be designed to be executed on a processor (e.g. on a control device of a vehicle or on external server to the vehicle), thus permitting the execution of at least one of the methods described in the present document.

According to a further aspect, a storage medium is described. The storage medium can comprise a SW program, which is designed to be executed on a processor, thus permitting the execution of at least one of the methods described in the present document.

It should be observed that the methods, devices and systems described in the present document can be employed either in isolation or in combination with other methods, devices and systems described in the present document. Moreover, any aspects of the methods, devices and systems described in the present document can be mutually combined in a variety of ways. In particular, the features described in the claims can be mutually combined in a variety of ways.

The invention is described in greater detail hereinafter with reference to exemplary embodiments.

### BRIEF DESCRIPTION OF THE DRAWINGS

FIG. 1 shows a block diagram of an exemplary charging system.

FIG. 2a shows an exemplary neural network.

FIG. 2b shows an exemplary neuron.

FIG. 2c shows an exemplary estimation unit.

FIG. 3 shows an exemplary pictorial representation of a road network with various charging stations.

FIG. 4a shows a flow diagram of an exemplary method for training an estimation unit.

FIG. 4b shows a flow diagram of an exemplary method for determining the overall amount of energy for a charging process.

### DETAILED DESCRIPTION OF THE DRAWINGS

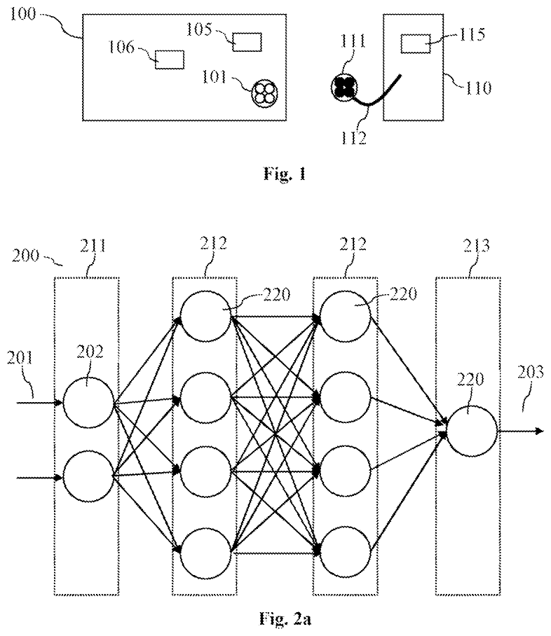

As described above, the present document addresses the determination, in an efficient and accurate manner, of the overall amount of energy for a charging process of an electrical energy store of a vehicle. In this connection, FIG. 1 shows a block diagram of an exemplary charging system having a charging station 110 and a vehicle 100. The vehicle 100 comprises an electrical energy store (not represented), which can be charged with electrical energy from the charging station 110. The vehicle 100 comprises a charging socket 101 (generally described as a charging interface), into which a corresponding (charging) plug connector 111 of a charging cable 112 can be plugged. The charging socket 101 and the plug connector 111 typically form a plug-in system. The charging cable 112 can be securely connected to the charging station (as represented). Alternatively, the charging cable 112 can be connected to the charging station 110 by way of a plug-in connection (e.g. in the case of AC charging).

The vehicle 100 can comprise a vehicle metering unit 105, which is designed to detect vehicle-related energy data with respect to the (vehicle-related) amount of energy which is drawn by the vehicle 100 in the context of a charging process, particularly via the charging socket 101. The charging station 110 can moreover comprise a charging station metering unit 115, which is designed to detect charging station-related energy data with respect to the (overall) amount of energy which is drawn by the charging station 110 (from an electric power supply grid) in the context of the charging process.

An evaluation device 106 of the vehicle 100 can be designed to determine, on the basis of vehicle-related energy data, the vehicle-related amount of energy which has been drawn by the vehicle 100 during a charging process. On the basis thereof, for example, costs for the charging process can be calculated. However, vehicle-related energy data take no account of energy losses, which occur on the charging cable 112 and/or in the charging station 110, and which typically result in an increased overall amount of energy for the charging process, in relation to the vehicle-related amount of energy. The charging station 110 typically bills the overall amount of energy for the charging process, such that costs for the charging process which are determined by the device 106 on the basis of vehicle-related energy data are typically lower than the actual costs billed.

It is thus not possible for the device 106 of a vehicle 100 to estimate or forecast, in an accurate manner, the overall amount of energy of a charging process, and thus the costs of a charging process. As a result, for example, the user of the vehicle 100 can select a charging station 110 for a charging process which features relatively high energy losses, and thus relatively high overall costs, in comparison with another charging station 110.

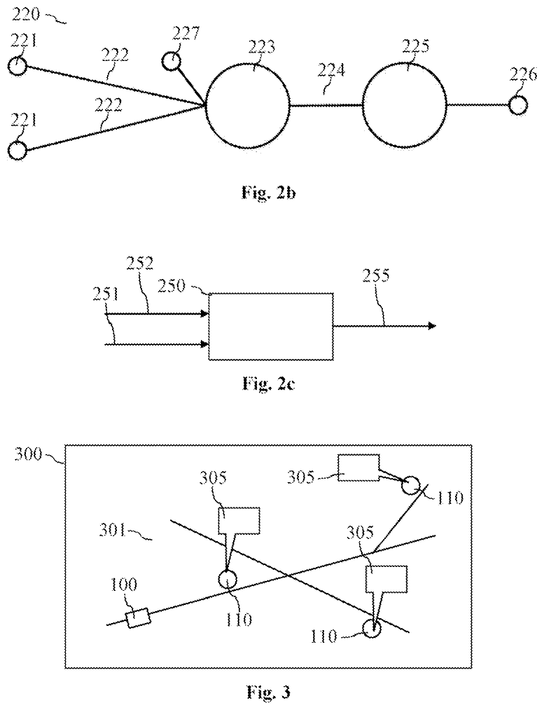

In order to permit an accurate estimation of the overall amount of energy for a charging process (optionally exclusively) on the basis of vehicle-related data with regard to the vehicle-related amount of energy drawn by the vehicle 100, as represented in an exemplary manner in FIG. 2c, a estimation unit 250 can be provided, and particularly can be trained, which is designed, on the basis of the vehicle-related amount of energy 251, to determine or estimate the overall amount of energy 255 for a charging process. The estimation unit 250 can thus be designed to estimate or forecast energy losses of a charging station 110 (including energy losses for the transmission operation to the vehicle 100) associated with a charging process.

The estimation unit 250 can be designed to determine the overall amount of energy 255 in a specific manner for individual charging stations 110 or for different types of charging stations 110, or for different types of charging processes (e.g. a charging station 110 for AC charging, a charging station 110 for DC charging, a charging station 110 for inductive charging, etc.). To this end, the estimation unit 250 can consider charging station data 252:
by way of which a specific charging station 110 in a network of charging stations 110 is identified; and/or
by way of which a specific type of charging station 110 or a specific type of charging process is identified from a plurality of different types of charging stations 110 or charging processes.

Alternatively or additionally, charging process data can be considered with reference to the charging capacity associated with a charging process.

The estimation unit 250 can be trained on the basis of a plurality of training data records for a corresponding plurality of (actually executed) charging processes. A training data record for a charging process can indicate the following:
the vehicle-related amount of energy 251 for the charging process determined by the vehicle metering unit 105,
optionally, charging station data 252 for the charging station 110 at which the charging process has been executed and/or for the type of charging process which has been executed;
optionally, charging process data relating to the charging capacity associated with the respective charging process; and
the overall amount of energy 255 for the charging process determined by the charging station metering unit 115.
   The estimation unit 250 can optionally comprise one or more analytical functions involving a plurality of functional parameters. In the context of a training method, functional parameters can be instructed or determined on the basis of a plurality of training data records (such that, e.g. a specific error criterion is reduced, and is particularly minimized).

Alternatively or additionally, the estimation unit 250 can comprise a neural network 200, as represented (in an exemplary manner in FIGS. 2a and 2c). The individual neuron parameters 222, 227 of the neural network 200 can be instructed on the basis of the plurality of training data records.

FIGS. 2a and 2b show exemplary components of a neural network 200, particularly of a feedforward network. In the example represented, the network 200 comprises two input neurons or input nodes 202 which, at a specific time point t, respectively assume a current value of an input variable by way of an input value 201. The one or more input nodes 202 form part of an input layer 211. Exemplary input variables are the vehicle-related amount of energy 251 and, optionally, charging station data 252 and, optionally, charging process data for a charging process.

The neural network 200 further comprises neurons 220 in one or more masked layers 212 of the neural network 200. Each of the neurons 220, by way of input values, can assume the individual output values of neurons in the preceding layer 212, 211 (or at least a proportion thereof). In each of the neurons 220, a processing operation is executed, in order to determine an output value of the neuron 220, according to the input values. The output values of neurons 220 in the final masked layer 212 can be processed in an output neuron or output node 220 of an output layer 213, in order to determine one or more output values 203 of the neural network 200. In the present example, by way of an output value 203, the overall amount of energy 255 for a charging process can be determined and delivered.

FIG. 2b illustrates exemplary signal processing within a neuron 220, particularly within the neurons 202 of the one or more masked layers 212 and/or of the output layer 213. Input values 221 of the neuron 220 are weighted by the application of individual weightings 222, in order to determine, in a summing unit 223, a weighted sum 224 of input values 221 (optionally in consideration of a bias or offset 227). By way of an activation function 225, the weighted sum 224 can be represented on an output value 226 of the neuron 220. Thus, for example, delimitation of a range of values can be executed by way of the activation function 225. For a neuron 220, for example, a sigmoid function, a hyperbolic tangent (tanh) function, or a rectified linear unit function (ReLU), e.g. f(x)=max(0,x) can be employed as an activation function 225. Optionally, the value of the weighted sum 224 can be displaced by the application of an offset 227.

A neuron 220 thus assumes weightings 222 and/or optionally an offset 227, by way of neuron parameters. Neuron parameters of the neurons 220 of a neural network 200 can instructed in a training phase (by reference to the plurality of training data records), in order to achieve the approximation by the neural network 200 of a specific function and/or the modeling of a specific behavior, particularly for the estimation, in an accurate manner, of the overall amount of energy 255 for a charging process.

The training of a neural network 200 can be executed, for example, by way of the backpropagation algorithm. To this end, in a first phase of a q^{th} epoch of a learning algorithm, for input values 201 at the one or more input nodes 202 of the neural network 200, corresponding output values 203 can be determined at the output of the one or more output neurons 220. On the basis of the output values 203, the error value of an optimization or error function can be determined.

In a second phase of the q^{th} epoch of the learning algorithm, backpropagation of the error or error value is executed from the output to the input of the neural network, for the layer-by-layer adjustment of the neuron parameters of the neurons 220. The error function thus determined at the output can be partially inferred in accordance with each individual neuron parameter of the neural network 200, in order to determine a magnitude and/or a direction of adjustment of the individual neuron parameters. This learning algorithm can be repeated in an iterative manner for a plurality of epochs, until a predefined convergence and/or interruption criterion is achieved.

The device 106 of the vehicle 100 can thus be designed to determine the vehicle-related amount of energy 251 for a charging process. The vehicle-related amount of energy 251 can be determined, for example, on the basis of the current state-of-charge of the energy store of the vehicle 100 (for a planned and forthcoming charging process). Alternatively or additionally, the vehicle related amount of energy 251 can be determined on the basis of vehicle energy data from the vehicle metering unit 105 (for a charging process currently in progress or already completed).

The device 106 can further be designed, by way of the previously trained estimation unit 250, on the basis of the vehicle-related amount of energy 251, and optionally in consideration of charging station data 252 with regard to the charging station 110 on which the charging process is executed or is to be executed, and optionally in consideration of charging process data for the charging process, to determine the overall amount of energy 255 for the charging process. The overall amount of energy 255 can then be optionally multiplied by a cost value for a quantitative unit of electrical energy (e.g. for a kWh), in order to determine or forecast total costs for the charging process.

The above-mentioned functionality can be employed, for example, in advance of a planned charging process, in order to propose an appropriate charging station 110 for the charging process to the user of a vehicle 100. FIG. 3 shows an exemplary pictorial representation 300 of a road network 301, on which the vehicle 100 is traveling. The pictorial representation 300 can be displayed, for example, on a screen of the vehicle 100 (e.g. as part of a navigation system of the vehicle 100). In the pictorial representation 300, one or more charging stations 110 in the vicinity of the vehicle 100 can be represented. Moreover, energy information 305 for the individual charging stations 110 can be displayed, wherein energy information 305 indicates, for example, the overall amount of energy 255 and/or overall costs generated by the charging process in the individual charging stations 110.

The user of the vehicle 100 is thus permitted, in a convenient manner, to select an appropriate charging station 110, e.g. the charging station 110 having the lowest overall amount of energy 255 for the charging process. User convenience and the energy efficiency of the vehicle 100 can be enhanced accordingly.

On the basis of multiple charging processes and the associated recording of data 251 [E_Vehicle] at the metering point 105 of the charging socket 101 on one or more vehicles 110, and data 255 [E_Overall] for the charging station (as an element of the estimation unit 250), a regression algorithm from the field of machine learning can be provided or trained. This algorithm can be designed, on the basis of vehicle-related data 251 and, optionally, on the basis of data 252 from the charging station 110 and, optionally, on the basis of charging process data, to calculate the overall amount of energy 255 for a charging process. As losses on the charging cable 112 and the charging station 110 are typically dependent upon one or more influencing factors, inputs for the algorithm are typically the vehicle-related amount of energy 251 [E_Vehicle], one or more further influencing factors such as, for example, the charging method (AC, DC), or one or more settings (e.g. the maximum charging current), or one or more hardware-related influences (e.g. a model of the charging cable 112). The one or more further influencing factors can be considered in the form of charging station data 252 and/or in the form of charging process data, in the context of the determination of the overall amount of energy 255.

By reference to the regression algorithm (i.e. by way of the estimation unit 250), losses on the charging cable 112 and the charging station 110 can be determined for individual charging stations 110 and/or for individual charging processes. As a result, an accurate energy and/or cost forecast can be delivered to a user, before the start of charging. The vehicle-related amount of energy 251, which charges the vehicle 100 during the charging process, is known to the vehicle 100, particularly on the grounds of one or more user settings.

Losses on the charging cable 112 and the charging station 110 can be added to this vehicle-related amount of energy 251, in order to determine the overall amount of energy 255. By the multiplication of the overall amount of energy 255 by the price of an energy unit [€/kWh], overall costs for the charging process can be determined.

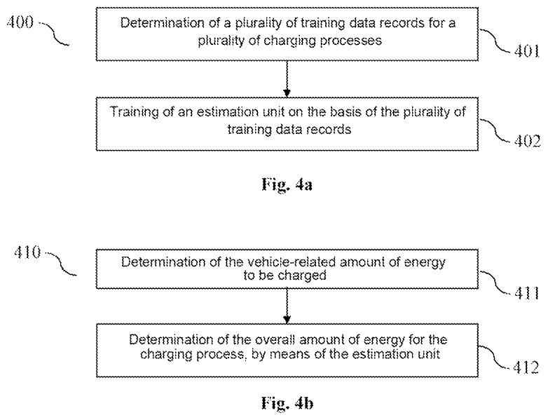

FIG. 4a shows a flow diagram of an exemplary (optionally computer-implemented) method 400 for the training of an estimation unit 250, in order to enable the estimation unit 250, on the basis of a vehicle-related amount of energy 251 in the form of electrical energy which is drawn by a vehicle 100 during a charging process at a charging station 110, to estimate the overall amount of energy 255 which is drawn by the charging station 110 for the charging process from an electric power supply source (e.g. from an electric power supply grid). The method 400 can be executed by a server (externally to the vehicle).

The method 400 comprises the determination 401 of a plurality of training data records for a corresponding plurality of (actually executed) charging processes. The training data record for an (actually executed) charging process can comprise the (actual) vehicle-related amount of energy 251 and the (actual) overall amount of energy 255 for the (actually executed) charging process. Training data can thus be provided which, in each case, for a plurality of charging processes, indicate the vehicle-related amount of energy 251 which is actually drawn by a vehicle 100 and the overall amount of energy 255 which is actually drawn by the charging station 110. Individual training data records can further comprise charging station data 252, which permit the identification of individual charging stations 110 and/or of the type of charging process executed on the individual charging stations 110. Individual training data records can further comprise charging process data, from which e.g. the (maximum) charging capacity for individual (actually executed) charging processes can be derived.

The method 400 further comprises the training 402 of the estimation unit 250 on the basis of the plurality of training data records. In particular, an analytical function and/or a neural network 200 can be trained on the basis of training data. By way of the machine training of an estimation unit 250, a robust, reliable and efficient estimation of the energy losses of individual charging stations 110 during charging processes is permitted.

FIG. 4b shows a flow diagram of an exemplary (optionally computer-implemented) method 410 for determining the overall amount of energy 255 for a charging process of an electrical energy store of an at least partially electrically-powered vehicle 100 at a charging station 110. The method 410 can be executed by a device 106 of the vehicle 100.

The method 410 comprises the determination 411 of the vehicle-related amount of energy 251 (i.e. the amount of electrical energy) which is drawn by the vehicle 100 for the charging process. The vehicle-related amount of energy 251 can indicate the amount of electrical energy which is drawn by the vehicle 100, e.g. at the charging socket 101 of the vehicle 100.

The method 410 further comprises the estimation 412, by way of a previously determined or (machine) trained estimation unit 250, on the basis of the vehicle-related amount of energy 251, of the overall amount of energy 255 which is drawn by the charging station 110 for the charging process from an electric power supply source. The overall amount of energy 255, in addition to the vehicle-related amount of energy 251, also comprises any energy losses within the charging station 110 and/or on the charging cable 112 between the charging station 110 and the vehicle 100.

By way of the measures described in the present document, the overall amount of energy for charging processes of a vehicle 100 can be determined in an efficient and accurate manner. Convenience for a user of the vehicle 100, and the energy efficiency of the vehicle 100, can be enhanced accordingly.

The present invention is not limited to the exemplary embodiments illustrated. In particular, it should be observed that the description and the figures are only intended to illustrate the principle of the proposed methods, devices and systems.

1.-12. (canceled)

13. A device for determining an overall amount of energy for a charging process of an electrical energy store of at least partially electrically-powered vehicle at a charging station, wherein the device is configured:
to determine a vehicle-related amount of energy, in a form of electrical energy, which is drawn by the vehicle for the charging process; and
to estimate, by way of a previously determined estimation unit, based on the vehicle-related amount of energy, an overall amount of energy which is drawn by the charging station for the charging process from an electric power supply source.

14. The device according to claim 13, wherein the device is further configured:
to determine charging station data with reference to the charging station; and
based on the charging station data, by way of the estimation unit, to determine the overall amount of energy.

15. The device according to claim 14, wherein the charging station data comprises at least one of:
an identifier for the identification of the charging station from a plurality of different charging stations; or
positional information with respect to a position of the charging station.

16. The device according to claim 14, wherein:
the charging station data indicate a type of charging process from a plurality of different types of charging processes which are executable on the charging station; and
the plurality of different types of charging processes comprise at least one of:
a DC charging process;
an AC charging process; or
an inductive charging process.

17. The device according to claim 13, wherein the device is further configured:
to determine charging process data with reference to the charging process, wherein the charging process data indicate a charging capacity for the charging process; and
by way of the estimation unit, to determine the overall amount of energy based on the charging process data.

18. The device according to claim 13, wherein the estimation unit is configured to estimate an amount of electrical energy losses which occur at least one of during the charging process on the charging station or on a charging cable between the charging station and the vehicle.

19. The device according to claim 13, wherein at least one of:
the estimation unit comprises an estimation algorithm, which is machine-trained beforehand based on training data, for estimation of the overall amount of energy for the charging process based on the vehicle-related amount of energy drawn by the vehicle; or
the estimation unit comprises a neural network, which is machine-trained beforehand based on the training data, for the estimation of the overall amount of energy for the charging process.

20. The device according to claim 13, wherein the device is further configured to at least one of:
determine the vehicle-related amount of energy for the charging process during the charging process, based on sensor data from an energy metering unit of the vehicle; or
determine the vehicle-related amount of energy for the charging process prior to commencement of the charging process, based on a state-of-charge of the electrical energy store of the vehicle.

21. The device according to claim 13, wherein the device is further configured:
for a plurality of different charging stations, to respectively determine, based on the vehicle-related amount of energy, the overall amount of energy for the charging process at the respective charging station; and
to deliver an output of energy information with respect to the overall amounts of energy thus determined for the plurality of different charging stations to a user of the vehicle.

22. The device according to claim 13, wherein the device is further configured:
to determine a plurality of training data records for a corresponding plurality of charging processes; wherein the training data record for a respective charging process indicates the vehicle-related amount of energy and the overall amount of energy for the respective charging process; and
to train the estimation unit based on the plurality of training data records.

23. A method for determining an overall amount of energy for a charging process of an electrical energy store of at least partially electrically-powered vehicle at a charging station, the method comprising:
determining a vehicle-related amount of energy, in a form of electrical energy, which is drawn by the vehicle for the charging process; and
estimating, by way of a previously determined estimation unit, based on the vehicle-related amount of energy, the overall amount of energy which is drawn by the charging station for the charging process from an electric power supply source.

24. A method for training of an estimation unit, wherein the estimation unit is enabled, based on a vehicle-related amount of energy in a form of electrical energy which is drawn by a vehicle during a charging process at a charging station, to estimate an overall amount of energy which is drawn for the charging process by the charging station from an electric power supply source, the method comprising:
determining a plurality of training data records for a corresponding plurality of charging processes, wherein the training data record for a respective charging process indicates the vehicle-related amount of energy and the overall amount of energy for the respective charging process; and
training the estimation unit based on the plurality of training data records.
